(19) United States
(12) Patent Application Publication
(10) Pub. No.: US 2011/0119015 A1
(43) Pub. Date: May 19, 2011

(54) GEOMAGNETIC SENSOR CONTROL DEVICE

(76) Inventors: Kisei Hirobe, Miyagi-Ken (JP); Hisashi Takaki, Miyagi-Ken (JP)

(21) Appl. No.: 13/011,471

(22) Filed: Jan. 21, 2011

Related U.S. Application Data
(63) Continuation of application No. PCT/JP2009/062407, filed on Jul. 8, 2009.

(30) Foreign Application Priority Data
Jul. 25, 2008 (JP) 2008-192209

(51) Int. Cl. G06F 19/00

(52) U.S. Cl. 702/104

(57) ABSTRACT

A geomagnetic sensor control device includes an analog circuit unit that outputs a plurality of magnetic field measurement values corresponding to sensor output signals of a plurality of magnetic sensors, and a digital circuit unit that receives three-axis magnetic field measurement values from the analog circuit unit and that performs digital processing. In the analog circuit unit, offset correction is performed in an analog manner on an offset included in a sensor output signal. In the digital circuit unit, sensitivity correction is performed in a digital manner on a magnetic field measurement value corresponding to the sensor output signal on which the offset correction has been performed.

### CLAIM OF PRIORITY

This application is a Continuation of International Application No. PCT/JP2009/062407 filed on Jul. 8, 2009, which claims benefit of Japanese Patent Application No. 2008-192209 filed on Jul. 25, 2008. The entire contents of each application noted above are hereby incorporated by reference.

### BACKGROUND OF THE INVENTION

1. Field of the Invention

The present invention relates to a geomagnetic sensor control device configured to receive sensor output signals from a plurality of magnetic sensors and to perform offset correction and sensitivity correction.

2. Description of the Related Art

In general, there is known a magnetic sensor including a bridge connection of a magnetoresistive element and a resistor, in which a change in resistance value corresponding to a change in magnetic field applied to the magnetoresistive element is extracted as a voltage. A geomagnetic detection device includes a plurality of magnetic sensors each having the above configuration, and is configured to detect a change in magnetic field in two-axis (X, Y) or three-axis (X, Y, Z) directions.

In a geomagnetic detection device including a plurality of magnetic sensors, sensitivity correction for correcting the variation in sensor sensitivity of sensors is performed because the variation in sensor sensitivity may lead to difficulty in acquisition of accurate measurement values (see, for example, Japanese Unexamined Patent Application Publication No. 2006-138843).

However, output signals of magnetic sensors in a geomagnetic detection device may be applied with an offset caused by the variation in sensor sensitivity as well as changes in gain due to temperature characteristics or the variation in resistance value or magnetic characteristics of sensors. Also in an integrated circuit, a circuit-unique voltage offset occurs in a power supply circuit or an amplification circuit, leading to an offset of a magnetic field in which the sum of the offset of the sensor outputs and the circuit-unique offset is detected.

Further, with the integrated circuit (IC) fabrication of geomagnetic sensor control devices configured to receive a sensor output signal from a geomagnetic sensor and to process the sensor output signal, there is a demand for a circuit layout capable of reducing the circuit size. A demand for more accurate measurement values also exists.

Accordingly, the present invention provides a geomagnetic sensor control device capable of reducing the circuit size and also obtaining accurate measurement values.

### SUMMARY OF THE INVENTION

According to an aspect of the present invention, a geomagnetic sensor control device includes an analog circuit unit configured to receive sensor output signals from a plurality of magnetic sensors and output a plurality of magnetic field measurement values corresponding to the plurality of sensor output signals, and a digital circuit unit configured to receive the plurality of magnetic field measurement values from the analog circuit unit and perform digital processing. The analog circuit unit performs offset correction in an analog manner on an offset included in the sensor output signals, and the digital circuit unit performs sensitivity correction in a digital manner on the magnetic field measurement values corresponding to the sensor output signals on which the offset correction has been performed.

With the above configuration, an offset of a magnetic sensor can be corrected in an analog manner, and sensitivity correction is performed in a digital manner, thus allowing a reduction in circuit size and improvement in measurement accuracy.

In the geomagnetic sensor control device according to the present invention, the analog circuit unit may include an input unit configured to selectively receive a sensor signal from one of the plurality of magnetic sensors, an offset correction processing unit configured to correct an offset of the one of the plurality of magnetic sensors in an analog manner on the basis of offset correction data during a process of amplifying the sensor signal selected by the input unit, an analog-to-digital converter configured to convert the sensor signal on which the offset correction has been performed by the offset correction processing unit into a digital magnetic field measurement value, and a data output unit configured to hold data output from the analog-to-digital converter. The digital circuit unit may include a memory configured to store offset correction data for offset correction performed by the analog circuit unit, the offset correction data corresponding to the plurality of magnetic sensors, and sensitivity correction data for correcting sensitivities of the magnetic sensors, a controller configured to read offset correction data from the memory and output the offset correction data to the offset correction processing unit when the analog circuit unit performs offset correction, and a digital correction circuit configured to read sensitivity correction data from the memory and perform sensitivity correction in a digital manner when sensitivity correction is performed on three-axis magnetic field measurement values received from the data output unit.

With the above configuration, the offset of the magnetic sensor is corrected in an analog manner during a process of amplifying the sensor signal selected by the input unit. Thus, a range of voltage outputs to be subjected to AD conversion can be mapped to a voltage to be measured, resulting in the efficient detection of the amplitude of a sensor output signal and furthermore more improved accuracy than that when offset correction is performed on a sensor output signal prior to amplification. In addition, since the digital circuit unit corrects the sensitivity of a magnetic sensor in a digital manner, more improved accuracy than that when sensitivity correction is performed in an analog manner can be realized, and the circuit size can also be reduced.

In the geomagnetic sensor control device according to the present invention, preferably, the offset correction data is set so that the offset correction processing unit corrects a sum of an amplifier offset generated when amplifying the sensor signal and a sensor offset included in an output of the one of the plurality of magnetic sensors.

In the geomagnetic sensor control device according to the present invention, furthermore, the analog circuit unit may further include a temperature sensor. The analog circuit unit may input an output signal of the temperature sensor to the analog-to-digital converter, convert the output signal into a digital temperature measurement value, and hold the digital temperature measurement value in the data output unit. The memory of the digital circuit unit may store at least gain correction data as the sensitivity correction data. The digital correction circuit may read the gain correction data from the memory, and perform, as the sensitivity correction, gain correction on the magnetic field measurement values and then temperature correction based on the temperature measurement value.

With the above configuration, the digital correction circuit can perform gain correction and temperature correction as sensitivity correction, and can obtain an accurate geomagnetic measurement value with gain variation or temperature drift corrected.

In the geomagnetic sensor control device according to the present invention, furthermore, the analog circuit unit and the digital circuit unit may be configured to perform sequence processing using START for giving an instruction for starting magnetic field measurement, RESET for giving a reset instruction, AMPCH for giving an instruction for changing an amplification factor of an amplifier, TCS for giving an instruction for starting temperature measurement, END for providing notification of completion of measurement, and BUSY for providing notification of a busy state of the analog circuit unit, the START, the RESET, the AMPCH, and the TCS being supplied from the digital circuit unit to the analog circuit unit, the END and the BUSY being supplied from the analog circuit unit to the digital circuit unit.

Therefore, the sequence processing of the analog circuit unit and the sequence processing of the digital circuit unit can be simplified.

In the geomagnetic sensor control device according to the present invention, furthermore, the memory may be a one-time programmable non-volatile memory that allows a single write operation.

According to the present invention, a geomagnetic sensor control device with a reduced circuit size can be achieved, and accurate measurement values can also be obtained.

### BRIEF DESCRIPTION OF THE DRAWINGS

FIG. 1 is an overall configuration diagram of a geomagnetic sensor control device according to an embodiment of the present invention;

FIG. 2 is a configuration diagram of correction data stored in a memory according to the embodiment;

FIG. 3 is a diagram describing a relationship between an input voltage range of a differential amplifier according to the embodiment and an offset;

FIG. 4 is a diagram illustrating the principle of operation of a magnetic sensor; and

FIG. 5 is a flow diagram illustrating a process procedure from the start of magnetic field measurement to the completion of data acquisition according to the embodiment.

### DESCRIPTION OF THE PREFERRED EMBODIMENTS

A geomagnetic sensor package including a plurality of magnetic sensors and a geomagnetic sensor control device according to an embodiment of the present invention will be described hereinafter with reference to the accompanying drawings.

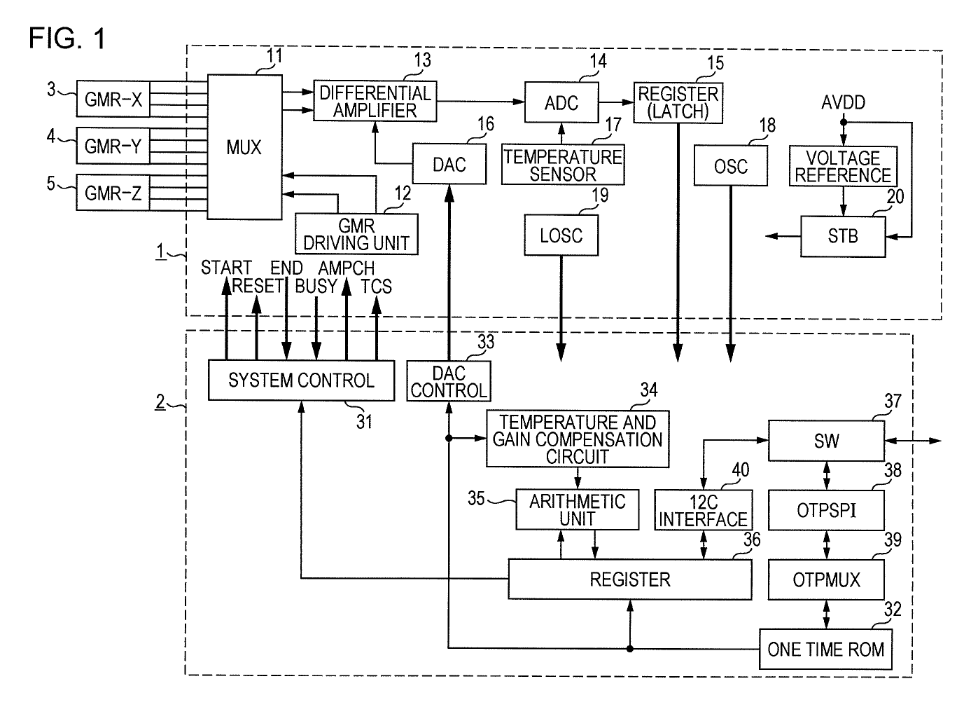

FIG. 1 is an overall configuration diagram of a geomagnetic sensor control device according to this embodiment. The geomagnetic sensor control device includes an analog circuit unit 1 configured to perform analog processing on sensor outputs, and a digital circuit unit 2 configured to operate in association with the analog circuit unit 1 using a simplified interface therebetween. For example, three-axis (for example, perpendicular X, Y, and Z-axis) magnetic sensors 3, 4, and 5 are connected to the analog circuit unit 1. In the illustrated example, the magnetic sensors 3, 4, and 5 may be giant magnetoresistive (GMR) sensors. However, other magnetic sensors may be used. The present invention can also be applied to a geomagnetic sensor control device to which two magnetic sensors associated with two axes are connected.

The analog circuit unit 1 includes a multiplexer 11 serving as an input unit that selectively receives weak sensor output signals output from the magnetic sensors 3, 4, and 5. The magnetic sensors 3, 4, and 5 are supplied with operating voltages from a GMR driving unit 12 provided in the analog circuit unit 1 via the multiplexer 11. A sensor output signal corresponding to one axis selected by the multiplexer 11 is input to a differential amplifier 13 for differential amplification, and a resulting signal is converted into a digital signal by an analog-to-digital (AD) converter 14. Three-axis magnetic field measurement values output from the AD converter 14 are latched in a register 15 that serves as a data output unit and that includes a latch circuit. The magnetic field measurement values or temperature measurement values temporarily held in the register 15 are received by the digital circuit unit 2 at a predetermined timing.

The analog circuit unit 1 further includes a digital-to-analog (DA) converter 16 configured to add a cancellation voltage for correcting the offset of the magnetic sensors 3, 4, and 5. The DA converter 16 converts an offset correction value supplied from the digital circuit unit 2 into an analog cancellation voltage, and applies the cancellation voltage to an input terminal of the differential amplifier 13. The differential amplifier 13 and the DA converter 16 may form an offset correction unit. The analog circuit unit 1 further includes a temperature sensor 17 to detect temperature data for correcting the change in sensitivity due to the change in temperature of the magnetic sensors 3, 4, and 5. The temperature sensor 17 detects the temperature of the analog circuit unit 1, which serves as an ambient environmental temperature of the magnetic sensors 3, 4, and 5, and inputs the detected temperature to the AD converter 14 to convert the temperature into a digital signal. The timing of selection of the X, Y, or Z axis by the multiplexer 11, the timing of offset correction of each sensor, the timing of measurement of temperature, and the like are controlled by control signals from the digital circuit unit 2 described below.

The analog circuit unit 1 further includes a high-frequency oscillator 18 configured to generate a control clock for analog units (the individual units in the analog circuit unit 1), a low-frequency oscillator 19 configured to generate a control clock for digital units (the individual units in the digital circuit unit 2), a stabilizing power supply 20 configured to supply power generated based on a reference voltage, and any other suitable device.

The digital circuit unit 2 includes a system controller 31 that controls the interface processing between the digital circuit unit 2 and the analog circuit unit 1. In this embodiment, an interface is configured to be established between the analog circuit unit 1 and the digital circuit unit 2 using simple control signals. Specifically, the control signals given from the digital circuit unit 2 to the analog circuit unit 1 may include START (instruction for starting magnetic field measurement), RESET (reset instruction), AMPCH (instruction for changing the amplification factor of the amplifier), and TCS (instruction for starting temperature measurement). Further, the control signals given from the analog circuit unit 1 to the digital circuit unit 2 may include END (notification of measurement completion) and BUSY (notification of busy state of the analog circuit unit).

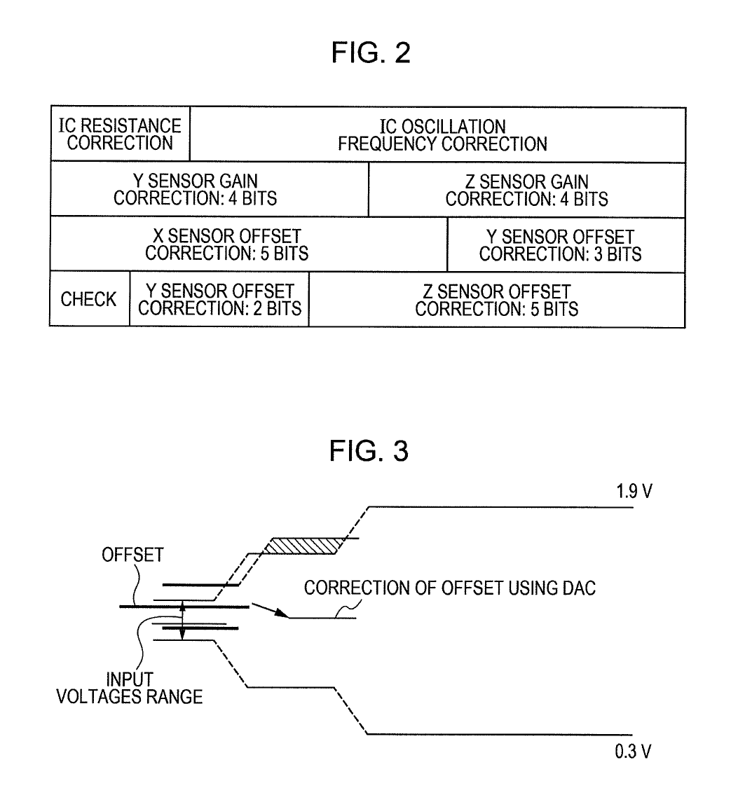

Correction data for offset correction and sensor sensitivity correction is stored in a memory 32. The memory 32 may be composed of, for example, an one-time programmable (OTP) non-volatile memory that is a non-volatile memory having a 32-bit storage area. OTP allows a single data storage operation and multiple read operations, and is efficient for reduction in circuit size. FIG. 2 illustrates the configuration of correction data stored in the memory 32. IC resistance correction data and IC oscillation frequency correction data are stored in the first word. In order to reduce the variation in IC manufacturing, correction data is determined at the time of wafer testing, and is stored in the first word. Y-axis gain correction data and Z-axis gain correction data are stored in the second word, and offset correction data of the X-axis sensor and a portion of offset correction data of the Y-axis sensor are stored in the third word. The remaining portion of the offset correction data of the Y-axis sensor and offset correction data of the Z-axis sensor are stored in the fourth word. In the illustrated example, the most significant 3 bits of the offset data of the Y-axis sensor are stored in the third word, and the least significant 2 bits of the offset data of the Y-axis sensor are stored in the fourth word, which total to 5 bits of data. The write timing of the correction data in the second to fourth words is different from that of the correction data in the first word. That is, measurement is performed in a state where a device is assembled after a magnetic sensor is mounted, and correction data is determined and is stored.

The offset correction data stored in the memory 32 is read by using a digital-to-analog converter (DAC) controller 33. Under timing control by the system controller 31, the DAC controller 33 reads offset correction data for each axis at an appropriate timing, and inputs the offset correction data to an input terminal of the DA converter 16 of the analog circuit unit 1. Thus, offset correction is performed in an analog manner during the amplification step by the differential amplifier 13. The digital circuit unit 2 may also be configured to include a correction data calculation mechanism so that the correction data calculation mechanism supplies offset correction data to the DAC controller 33. In this case, the system controller 31 may give a trigger for calculation of offset correction data to the correction data calculation mechanism.

FIG. 3 is a diagram describing a relationship between an input voltage range (dynamic range) of the differential amplifier 13 and an offset. It is assumed that the differential amplifier 13 performs two-stage amplification. The offset of a magnetic sensor is input to the differential amplifier 13 as a voltage offset. The amount of offset is canceled in an analog manner and is corrected to a predetermined value. The offset of the magnetic sensor has been measured in such a way as to include the variation that may occur in IC manufacturing and the offset produced during the amplification step by the differential amplifier 13 in a state where the magnetic sensor has been assembled. Thus, the offset produced during the amplification step by the differential amplifier 13 can also be corrected by the analog offset correction. If the offset (voltage) of the magnetic sensor is deviated to either side (in FIG. 3, to the upper side) with respect to the center of the input voltage range of the differential amplifier 13, as indicated by hatching in FIG. 3, amplification may cause deviation from the dynamic range, resulting in a possibility of accurate measurement values not being obtained. Therefore, the voltage offset input to the differential amplifier 13 is added to the cancellation voltage for offset correction, which is input from the DA converter 16, so that the offset of the magnetic sensor is corrected to be at the center of the input voltage range. In the example illustrated in FIG. 3, the cancellation voltage is added to the voltage offset whose range is extended by performing the first stage of amplification using the differential amplifier 13, so that the voltage offset is shifted to the center of the input voltage range. The second stage of amplification is further performed in a state where the offset has been corrected, so that the amplification is finally performed with a required amplification factor. Therefore, since offset correction is performed after the first stage of amplification is performed, high-accuracy offset correction can be performed.

A temperature and gain compensation circuit 34 of the digital circuit unit 2, which serves as a digital correction circuit, performs digital sensor sensitivity correction (digital correction). The temperature and gain compensation circuit 34 performs gain correction on the Y-axis magnetic field measurement value and the Z-axis magnetic field measurement value with respect to the X-axis magnetic field measurement value so that the Y and Z-axis gains are added to the X-axis gain. The temperature and gain compensation circuit 34 further performs sensitivity correction on the X, Y, and Z-axis magnetic field measurement values using correction coefficients corresponding to the sensor temperatures. An arithmetic operation necessary for digital correction in the digital circuit unit 2 is performed using an arithmetic unit 35 and a register 36.

The magnetic field measurement values obtained by the temperature and gain compensation circuit 34 using digital correction are held in the register 36, and are introduced into an external device outside the IC via an external interface 40 and a switch 37. Further, the content stored in the memory 32 can be updated from the external device. The external device accesses a predetermined bit of the memory 32 via an OTP serial peripheral interface (SPI) 38 and an OTP multiplexer 39, and updates the correction data. The OTP SPI 38 has a function for simply accessing an OTP-specific register and intercommunicating data with the register.

Next, the operation according to this embodiment with the above configuration will be described.

At the time of wafer testing of the analog circuit unit 1 and the digital circuit unit 2, the oscillation frequencies of the high-frequency oscillator 18 and the low-frequency oscillator 19 and the resistance values of the analog units are measured, resistance correction data and oscillation frequency correction data for reducing the variation between ICs are determined, and the determined data is written in a predetermined bit of the memory 32 of the digital circuit unit 2.

Next, the three-axis magnetic sensors 3, 4, and 5 are attached to the analog circuit unit 1 and are assembled as devices. After the attachment of the magnetic sensors 3, 4, and 5, data for gain correction and temperature correction is determined.

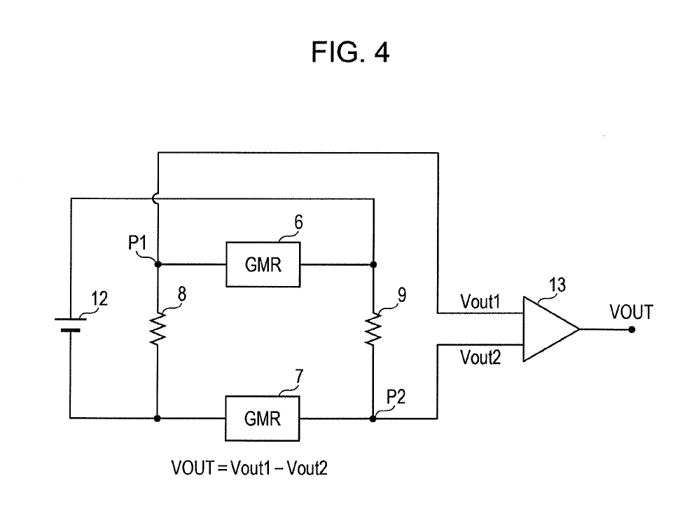

FIG. 4 is a diagram illustrating the principle of operation of each magnetic sensor (3, 4, 5). GMR elements 6 and 7 serving as magnetoresistive elements and resistors 8 and 9 are bridge-connected, and a driving voltage is applied to a magnetic sensor (3, 4, 5) selected by the multiplexer 11 from the GMR driving unit 12. Voltages Vout1 and Vout2 at middle points P1 and P2 of a bridge circuit forming the magnetic sensor are extracted and are input to the differential amplifier 13 for differential amplification. A magnetic field measurement value output from the differential amplifier 13 is converted into a digital value by the AD converter 14, and is temporarily held in the register 15. The three-axis magnetic field measurement values held in the register 15 are analyzed to determine correction data for sensor sensitivity correction.

Gain correction data for correcting the variation in the sensitivity of the X-axis, Y-axis, and Z-axis sensors is determined for the Y axis and the Z axis with respect to the X axis. The X-axis, Y-axis, and Z-axis magnetic field measurement values are received, and gain correction data for modification to the variation in sensitivity within, for example, 2% is determined and is stored in the memory 32. In the digital gain correction performed by the temperature and gain compensation circuit 34, the magnetic field measurement values are multiplied by correction coefficients to calculate gain correction values. Thus, the gain correction data may be stored in the memory 32 in the form of a gain correction coefficient, or data for determining a gain correction coefficient may be stored in the memory 32 as gain correction data, and calculation may be performed.

Since the magnetic field detection sensitivity of the magnetic sensors 3, 4, and 5 changes depending on the temperature, X-axis, Y-axis, and Z-axis magnetic field measurement values are measured under a variety of temperature conditions, and temperature correction coefficients for temperature compensation corresponding to the respective temperatures are determined. The temperature correction coefficients are set for respective temperatures within a specified temperature range, and the amount of data is therefore large. Thus, preferably, the temperature correction coefficients are written in a prepared temperature register. In the illustrated example, the register 36 of the digital circuit unit 2 may have an area reserved as a temperature register. However, any register other than the register 36, which is accessible from the temperature and gain compensation circuit 34, may also be used.

Further, after the magnetic sensors 3, 4, and 5 corresponding to three axes are attached to the analog circuit unit 1 and are assembled into a device, offset correction data for each of the magnetic sensors 3, 4, and 5 is determined and is stored in the memory 32. The offset correction data may be a digital value configured such that when converted into an analog cancellation voltage by the DA converter 16 and canceled out with the voltage offset in an analog manner, the center of the voltage offset input to the differential amplifier 13 is corrected to be at the center of the input voltage range. Such offset correction data is determined for each of the magnetic sensors 3, 4, and 5, and is stored in the memory 32.

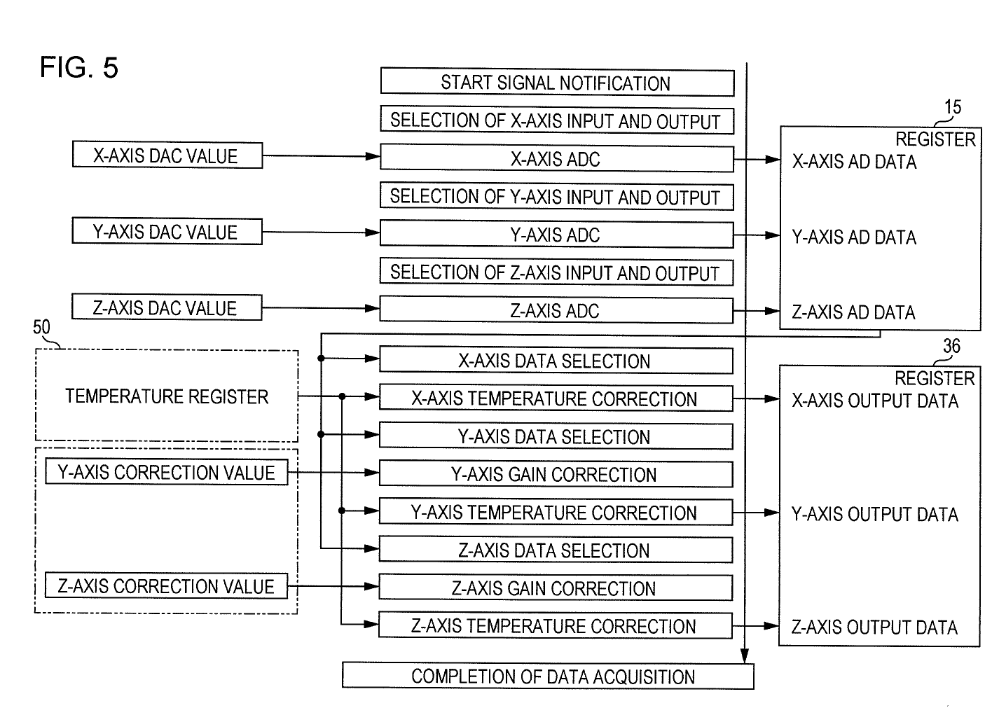

Next, a process procedure from the start of magnetic field measurement to the completion of data acquisition through offset correction, gain correction, and temperature correction will be described with reference to FIG. 5.

Magnetic field measurement is started in response to notification of a START signal sent from the system controller 31 to the analog circuit unit 1. In the analog circuit unit 1, the multiplexer 11 selects an X-axis input and output. That is, the X-axis magnetic sensor 3 is selected and a driving voltage is applied from the GMR driving unit 12 to the magnetic sensor 3. In addition, the voltages Vout1 and Vout2 at the middle points P1 and P2 of the bridge circuit are input to the differential amplifier 13, and the first stage of amplification is performed. In this case, the DAC controller 33 reads the offset correction data for the X-axis magnetic sensor 3 from the memory 32, and inputs the offset correction data to the DA converter 16. The voltage offset of the X-axis magnetic sensor 3 on which the first stage of amplification has been performed by the differential amplifier 13 is canceled with the cancellation voltage of the DA converter 16, which is obtained by performing AD conversion on the offset correction data, and offset correction is performed so that the center of the offset is shifted to the center portion in the input voltage range. Therefore, the range of voltage outputs to be subjected to AD conversion can be appropriately mapped to the input voltage range to be measured, and the amplitude of the sensor output signal can be efficiently detected. The X-axis sensor output on which offset correction has been performed in an analog manner in the above way is converted into a digital magnetic field measurement value by the AD converter 14, and is held in the register 15.

At the next timing the X-axis magnetic field measurement value is latched in the register 15, the Y-axis input and output are selected. The multiplexer 11 switches the connection destination from the X-axis magnetic sensor 3 to the Y-axis magnetic sensor 4, and the DAC controller 33 switches the offset correction data to be read from the memory 32 and to be input to the DA converter 16 from the X-axis offset correction data to the Y-axis offset correction data. Therefore, the voltages Vout1 and Vout2 at the middle points P1 and P2 of the Y-axis magnetic sensor 4 are input to the differential amplifier 13 for the first stage of amplification. In addition, offset correction is performed by adding to the voltage offset the cancellation voltage that is the amount of Y-axis offset correction to be applied from the DA converter 16. Then, the resulting value is converted into a digital value by the AD converter 14, and is then held in the register 15.

At the next timing the Y-axis magnetic field measurement value is latched in the register 15, the Z-axis input and output are selected. The multiplexer 11 switches the connection destination from the Y-axis magnetic sensor 3 to the Z-axis magnetic sensor 5, and the DAC controller 33 switches the offset correction data to be read from the memory 32 from the Y-axis offset correction data to the Z-axis offset correction data. Therefore, the output voltages Vout1 and Vout2 of the Z-axis magnetic sensor 5 are input to the differential amplifier 13 for the first stage of amplification. In addition, offset correction is performed with the cancellation voltage that is the amount of Z-axis offset correction to be applied from the DA converter 16. Then, the resulting value is converted into a digital value by the AD converter 14, and is then held in the register 15.

Accordingly, the X-axis, Y-axis, and Z-axis magnetic field measurement values are stored in the register 15. Then, an END signal for notification of the completion of measurement is sent from the analog circuit unit 1 to the system controller 31 of the digital circuit unit 2.

Upon receipt of the END signal from the analog circuit unit 1, the system controller 31 gives a TCS signal that is an instruction for starting temperature measurement to the analog circuit unit 1. In the analog circuit unit 1, the output signal of the temperature sensor 17 is converted into a digital value by the AD converter 14, and is then held in the register 15. After the completion of temperature measurement, an END signal is sent from the analog circuit unit 1 to the system controller 31.

The temperature measurement for sensitivity correction may not necessarily be performed immediately after the measurement of X-axis, Y-axis, and Z-axis magnetic fields, and may be performed, as desired, at the timing at which the sensor temperatures can be recognized. The system controller 31 instructs the temperature and gain compensation circuit 34 to receive the temperature measurement values from the register 15.

When the system controller 31 receives the END signal from the analog circuit unit 1 and determines magnetic field measurement has been completed, X-axis data is selected as data to be subjected to sensitivity correction. The temperature and gain compensation circuit 34 receives the X-axis magnetic field measurement value from the register 15, reads the temperature correction coefficient corresponding to the sensor temperature from a temperature register 50, multiplies the X-axis magnetic field measurement value by the temperature correction coefficient, and holds a temperature-corrected output value in the register 36 as X-axis output data. The sensor temperature is the most recent value read from the register 15.

An example of temperature correction will be described. Y-axis and Z-axis temperature correction is also performed in a similar manner. For example, a temperature correction coefficient can be calculated by temperature×coefficient+correction segment. The term “correction segment” means a reference value used for correction. A temperature correction coefficient corresponding to a sensor temperature is determined in advance, and is stored in the temperature register 50. An output value can be calculated by temperature correction coefficient×gain correction value (magnetic field measurement value). Since the X axis is used as a gain correction reference, gain correction is not performed for the X axis. Therefore, the X-axis gain correction value is equal to the magnetic field measurement value. If the magnetic field measurement value is 13-bit data ranging from 0 to 8191, an overflow may occur for 8192 or greater and the output value is fixed to 8191.

When the X-axis output data is held in the register 36, Y-axis data is selected at the next timing. The temperature and gain compensation circuit 34 receives the Y-axis magnetic field measurement value from the register 15, reads the Y-axis gain correction data from the memory 32, and performs correction so as to add the Y-axis gain to the X-axis gain as a reference.

An example of gain correction will be described. Z-axis gain correction is also performed in a similar manner. For example, the gain correction coefficient is calculated by gain correction data in the memory 32×coefficient+correction segment. The gain correction value can be calculated by magnetic field measurement value×gain correction coefficient/512. The gain correction coefficient may be stored in the memory 32 as gain correction data. Further, if the magnetic field measurement value is 13-bit data ranging from 0 to 8191, it is converted into a signed integer ranging from −4096 to 4095 prior to correction.

When the Y-axis output data is held in the register 36, then, Z-axis data is selected, and gain correction is performed first in a manner similar to that for the Y axis, and then temperature correction is performed. Resulting data is held in the register 36 as Z-axis output data.

Accordingly, when the X-axis output data, the Y-axis output data, and the Z-axis output data are written in the register 36, data acquisition is completed.

It is to be understood that the present invention is not limited to the foregoing embodiment, and a variety of modifications can be made without departing from the scope of the present invention.

The present invention can be applied to a geomagnetic sensor control device that performs analog processing and digital processing on an output signal of a magnetic sensor.

What is claimed is:

1. A geomagnetic sensor control device comprising:
an analog circuit unit configured to receive sensor output signals from a plurality of magnetic sensors and output a plurality of magnetic field measurement values corresponding to the plurality of sensor output signals; and
a digital circuit unit configured to receive the plurality of magnetic field measurement values from the analog circuit unit and perform digital processing,
wherein the analog circuit unit performs offset correction in an analog manner on an offset included in the sensor output signals, and the digital circuit unit performs sensitivity correction in a digital manner on the magnetic field measurement values corresponding to the sensor output signals on which the offset correction has been performed.

2. The geomagnetic sensor control device according to claim 1,
wherein the analog circuit unit includes
an input unit configured to selectively receive a sensor signal from one of the plurality of magnetic sensors,
an offset correction processing unit configured to correct an offset of the one of the plurality of magnetic sensors in an analog manner on the basis of offset correction data during a process of amplifying the sensor signal selected by the input unit,
an analog-to-digital converter configured to convert the sensor signal on which the offset correction has been performed by the offset correction processing unit into a digital magnetic field measurement value, and
a data output unit configured to hold data output from the analog-to-digital converter, and
wherein the digital circuit unit includes
a memory configured to store offset correction data for offset correction performed by the analog circuit unit, the offset correction data corresponding to the plurality of magnetic sensors, and sensitivity correction data for correcting sensitivities of the magnetic sensors,
a controller configured to read offset correction data from the memory and output the offset correction data to the offset correction processing unit when the analog circuit unit performs offset correction, and
a digital correction circuit configured to read sensitivity correction data from the memory and perform sensitivity correction in a digital manner when sensitivity correction is performed on three-axis magnetic field measurement values received from the data output unit.

3. The geomagnetic sensor control device according to claim 2,
wherein the offset correction data is set so that the offset correction processing unit corrects a sum of an amplifier offset generated when amplifying the sensor signal and a sensor offset included in an output of the one of the plurality of magnetic sensors.

4. The geomagnetic sensor control device according to claim 2,
wherein the analog circuit unit further includes a temperature sensor,
wherein the analog circuit unit inputs an output signal of the temperature sensor to the analog-to-digital converter, converts the output signal into a digital temperature measurement value, and holds the digital temperature measurement value in the data output unit,
wherein the memory of the digital circuit unit stores at least gain correction data as the sensitivity correction data, and
wherein the digital correction circuit reads the gain correction data from the memory, and performs, as the sensitivity correction, gain correction on the magnetic field measurement values and then temperature correction based on the temperature measurement value.

5. The geomagnetic sensor control device according to claim 1,
wherein the analog circuit unit and the digital circuit unit are configured to perform sequence processing using START for giving an instruction for starting magnetic field measurement, RESET for giving a reset instruction, AMPCH for giving an instruction for changing an amplification factor of an amplifier, TCS for giving an instruction for starting temperature measurement, END for providing notification of completion of measurement, and BUSY for providing notification of a busy state of the analog circuit unit, the START, the RESET, the AMPCH, and the TCS being supplied from the digital circuit unit to the analog circuit unit, the END and the BUSY being supplied from the analog circuit unit to the digital circuit unit.

6. The geomagnetic sensor control device according to claim 2,
wherein the memory is a one-time programmable non-volatile memory that allows a single write operation.

7. A geomagnetic sensor package comprising:
a plurality of magnetic sensors; and
the geomagnetic sensor control device according to claim 1.
